(19) United States
(12) Patent Application Publication
(10) Pub. No.: US 2025/0130870 A1
(43) Pub. Date: Apr. 24, 2025

(54) OPTIMIZING APPLICATION PROGRAMMING INTERFACE SYSTEM SCALABILITY IN A CLOUD ENVIRONMENT

(71) Applicant: Cisco Technology, Inc., San Jose, CA (US)

(72) Inventor: Prasenjit Sarkar, Isleworth (GB)

(21) Appl. No.: 18/383,093

(22) Filed: Oct. 24, 2023

(51) Int. Cl. G06F 9/54

(52) U.S. Cl. CPC G06F 9/541; G06F 9/546

(57) ABSTRACT

In one embodiment, a method herein comprises: collecting, by a process, data corresponding to one or more variables used to measure convertibility of a particular synchronous application programming interface call into an asynchronous application programming interface call; performing, by the process, an analysis on the data to determine relationships between the one or more variables; making a determination, by the process and based on the analysis, as to whether to convert the particular synchronous application programming interface call to the asynchronous application programming interface call; and converting, by the process and based on the determination, the particular synchronous application programming interface call to the asynchronous application programming interface call.

### TECHNICAL FIELD

The present disclosure relates generally to computer systems, and, more particularly, to optimizing application programming interface system scalability in a cloud environment.

### BACKGROUND

In today's modern cloud world, the Application Programming Interface (API) first strategy is the de facto standard for almost all modern companies. One of the major components of API-first strategy is API management. API management generally involves the creation, publication, documentation, and/or maintenance of APIs. However, there are some challenges associated with API managements.

For example, security, which entails ensuring that APIs are secure and protecting sensitive data from unauthorized access is a major concern in API management. This includes protecting against common security threats such as injection attacks, cross-site scripting, and denial of service attacks. In addition, scalability, whereby APIs are able to handle large volumes of traffic and/or handle sudden spikes in demand without crashing or slowing down, can be a major concern in APL management. Scalability can require careful planning and infrastructure to ensure that the API can scale effectively.

Integration can be another major challenge in API management. For example, APIs must be able to integrate seamlessly with a wide range of systems and technologies, including different programming languages, databases, and platforms. This can be a complex and time-consuming process, especially when integrating with legacy systems. Yet another key challenge to API managements is documentation. For example, clear and accurate documentation may be essential for developers to understand and use APIs effectively and, accordingly, maintaining accurate and up-to-date documentation can be a challenge, especially as APIs evolve over time.

Monitoring is still another key challenge to API management. For example, APIs must be monitored to ensure that they are performing optimally and to identify and fix any issues that arise. This can require a robust monitoring system that can track key metrics such as response times, error rates, and traffic patterns. Finally, governance can be a key challenge to API management. API governance can refer to the establishment and enforcement of policies and best practices for the use of APIs to ensure that they are used effectively and efficiently. This can include setting standards for how APIs are designed and developed, as well as how they are used and managed.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example application programming interface environment;

FIG. 4 illustrates an example of a system for optimized application programming interface scalability in a cloud environment in accordance with the disclosure; and

FIG. 5 illustrates an example simplified procedure for optimized application programming interface system scalability in a cloud environment.

### DESCRIPTION OF EXAMPLE EMBODIMENTS

### Overview

According to one or more embodiments of the disclosure, techniques are introduced herein that provide optimized application programming interface system scalability in a cloud environment. In particular, the techniques herein may first collect data corresponding to one or more variables used to measure convertibility of a particular synchronous application programming interface call into an asynchronous application programming interface call. Analysis on the data to determine relationships between the one or more variables may then be performed such that a determination as to whether to convert the particular synchronous application programming interface call to the asynchronous application programming interface call may be made. Based on the determination, the particular synchronous application programming interface call may be converted to an asynchronous application programming interface call.

Other embodiments are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

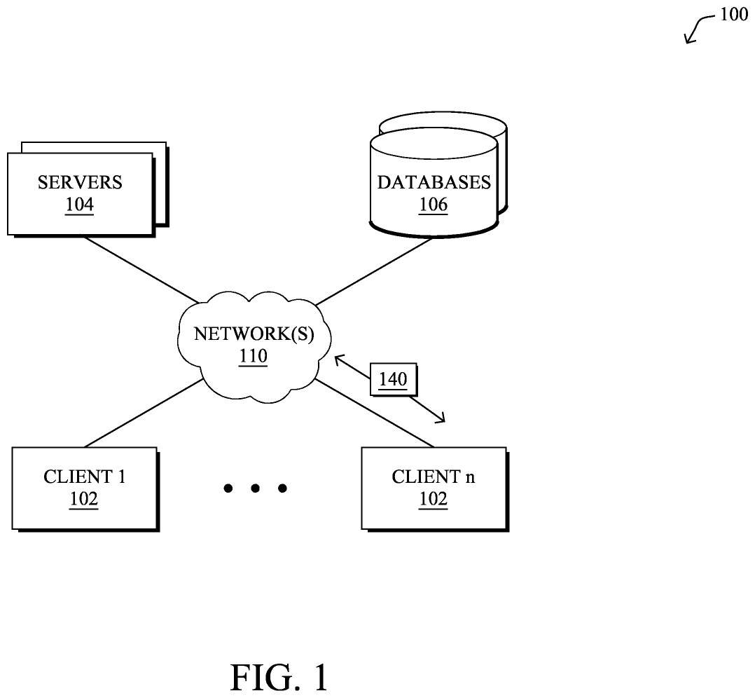

FIG. 1 is a schematic block diagram of an example simplified computing system 100 illustratively comprising any number of the client devices 102 (e.g., a first through nth client device), one or more of servers 104, and one or more of databases 106, where the devices may be in communication with one another via any number of networks (e.g., networks 110). The one or more networks (e.g., networks 110) may include, as would be appreciated, any number of specialized networking devices such as routers, switches, access points, etc., interconnected via wired and/or wireless connections. For example, devices 102-104 and/or the intermediary devices in network(s) (e.g., networks 110) may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) (e.g., networks 110).

Notably, in some embodiments, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in simplified computing system 100, and that the view shown herein is for simplicity. Also, those skilled in the art will further understand that while the network is shown in a certain orientation, the simplified computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

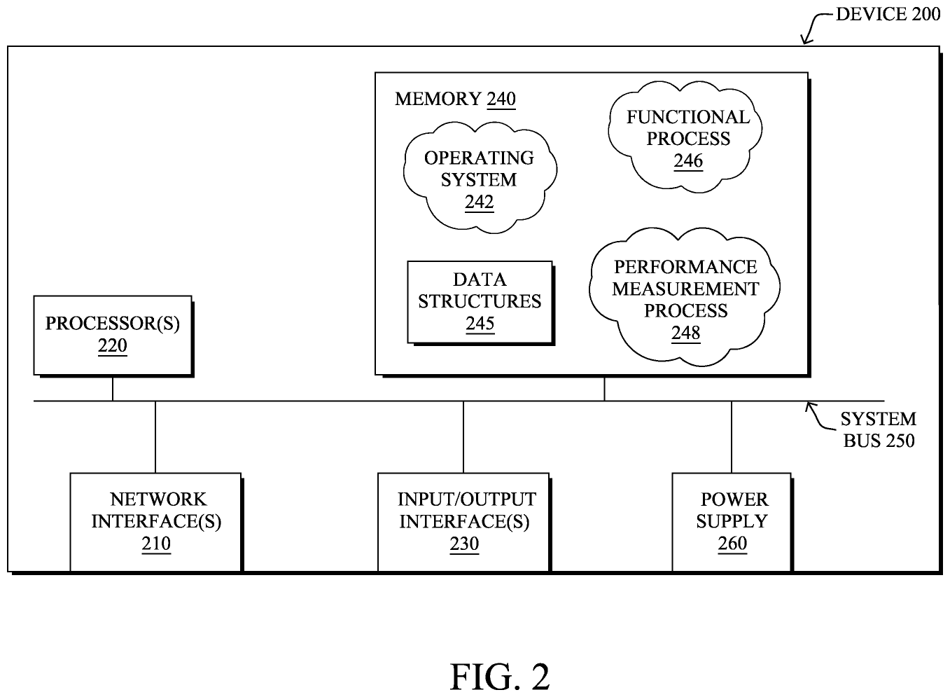

FIG. 2 is a schematic block diagram of an example node/device 200 that may be used with one or more embodiments described herein, e.g., as any of the devices 102-106 shown in FIG. 1 above. Device 200 may comprise one or more network interfaces (e.g., network interfaces 210) (e.g., wired, wireless, etc.), at least one processor (e.g., processor 220), and a memory 240 interconnected by a system bus 250, as well as a power supply 260 (e.g., battery, plug-in, etc.).

The network interface(s) (e.g., network interfaces 210) contain the mechanical, electrical, and signaling circuitry for communicating data over links coupled to the network(s) (e.g., networks 110). The network interfaces may be configured to transmit and/or receive data using a variety of different communication protocols. Note, further, that device 200 may have multiple types of network connections via network interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise one or more of functional processes 246, and on certain devices, a performance measurement process 248, illustratively, as described herein. Notably, functional processes 246, when executed by processor(s) (e.g., processor 220), cause each particular device (e.g., device 200) to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

In some embodiments, the functional processes 246 can include routing processes, which can include computer executable instructions executed by one or more processors, e.g., the processor 220 to perform functions provided by one or more routing protocols, such as the Interior Gateway Protocol (IGP) (e.g., Open Shortest Path First, “OSPF,” and Intermediate-System-to-Intermediate-System, “IS-IS”), the Border Gateway Protocol (BGP), Border Gateway Protocol Link-State (BGP-LS), etc., as will be understood by those skilled in the art. These functions may be configured to manage a forwarding information database including, e.g., data used to make forwarding decisions. In particular, changes in the network topology may be communicated among devices 200 using routing protocols, such as the conventional OSPF and IS-IS link-state protocols (e.g., to “converge” to an identical view of the network topology).

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

### —Optimizing API Scalability in a Cloud Environment—

As noted above, various challenges, such as security, scalability, integration, documentation, monitoring, and/or governance can be associated with API management. However, it is arguable that, among these challenges, scalability is one of the biggest and most difficult challenges in API management. For example, because APIs are often tasked with handling large volumes of traffic and/or sudden spikes in demand without crashing or slowing down, it can be difficult to adequately plan and provide satisfactory infrastructure resources to ensure that the API can scale effectively.

The techniques herein therefore provide for optimizing API system scalability, particularly in cloud computing environments. For example, the techniques described herein may allow for a business to increase the scalability of both existing APIs while allowing for scalability of new APIs that may be added to a business's API repertoire, including APIs that may be developed in the future. These and other aspects of the present disclosure can therefore allow for scalability of systems, particularly those that employ APIs in an “API-first” paradigm without hindering performance and/or while providing cost optimization to existing systems.

For example, through utilization of the optimization techniques described herein, a business may be able to determine an optimal performance of APIs and change the type of APIs to provide optimum scalability, thereby addressing one of the most challenging aspects of API management—namely—API scalability.

Illustratively, the techniques described herein may be performed by hardware, software, and/or firmware, such as in accordance with performance measurement process 248, which may include computer executable instructions executed by the processor 220 (or independent processor of network interfaces 210) to perform functions relating to the techniques described herein.

Specifically, according to various embodiments, an illustrative method herein may comprise: collecting, by a process (or a device that implements said process), data corresponding to one or more variables used to measure convertibility of a particular synchronous application programming interface call into an asynchronous application programming interface call; performing, by the process, an analysis on the data to determine relationships between the one or more variables; making a determination, by the process and based on the analysis, as to whether to convert the particular synchronous application programming interface call to the asynchronous application programming interface call; and converting, by the process and based on the determination, the particular synchronous application programming interface call to the asynchronous application programming interface call.

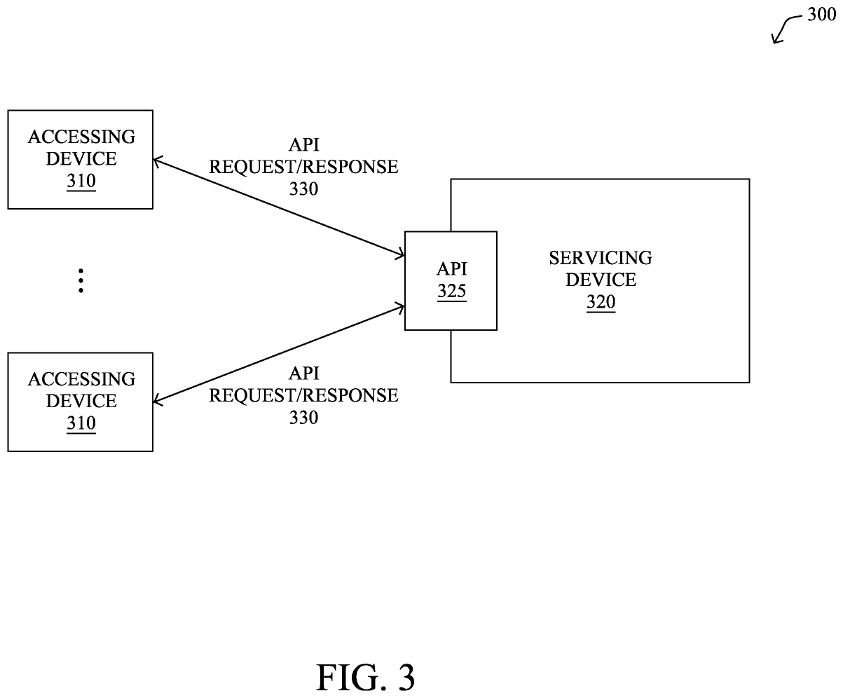

FIG. 3 illustrates an example, and simplified, API environment 300. As shown in FIG. 3, the API environment 300 includes accessing device 310 (e.g., a plurality of accessing devices), an application programming interface 325 (or “API”), and a servicing device 320. The accessing device 310 is in communication with the application programming interface 325 to transmit API request/response 330 packets between the accessing device 310 and the servicing device 320 via, e.g., the application programming interface 325.

In some embodiments, the servicing device 320 can be a server, database, or other device with which the accessing device 310 transmits the API request/response 330 packets. For example, the application programming interface 325 can transmit a request (as part of the API request/response 330) to the accessing device 310. The request can be, for example, an API call that is used to request information about an external service or program that the servicing device 320 may like to execute. The accessing device 310 can then transmit a response (as part of the API request/response 330) to the application programming interface 325 to facilitate execution of the external service or program by the servicing device 320.

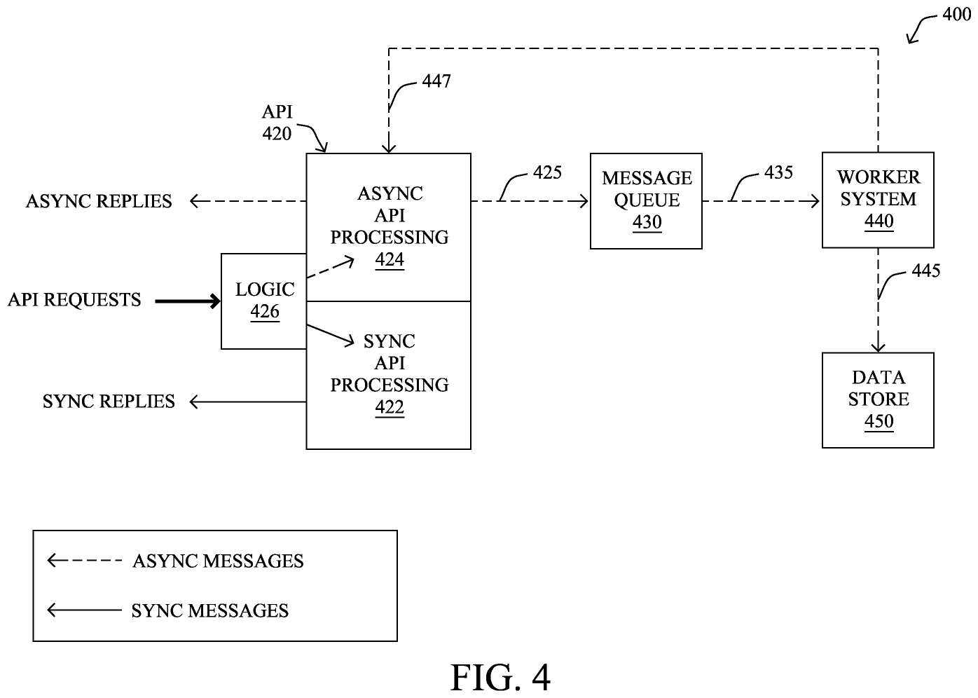

Operationally and according to various embodiments, FIG. 4 illustrates an example of a system for application programming interface scalability in a cloud environment in accordance with the disclosure. The system 400 can be analogous to the simplified computing system 100 of FIG. 1, device 200 of FIG. 2, and/or the API environment 300 of FIG. 3. As shown in FIG. 4, the system 400 includes an application programming interface 420 (or “API”), a message queue 430, a worker system 440, and a data store 450. In various embodiments, the system 400 is part of a cloud computing system or “cloud environment.” The application programming interface 420 can perform asynchronous API processing 424 and/or synchronous API processing 422 in response to a decision made by the logic 426, as described in greater detail herein.

For instance, as shown in FIG. 4, an API request can be received by the logic 426, and one or more of the methodologies described herein may be employed by the application programming interface 420 to optimize API scalability, particularly in a cloud environment, in accordance with the disclosure. Specifically, the API request can be processed by the logic 426 to determine whether the API request should be processed asynchronously (e.g., by the asynchronous API processing 424) or synchronously (e.g., by the synchronous API processing 422). If the API request is processed synchronously, a synchronous reply is returned in response to the API request, as shown in FIG. 4. If, on the other hand, the logic 426 determines that API request is to be processed asynchronously (e.g., by the asynchronous API processing 424), then asynchronous processing may be used as described below.

Although there may be multiple ways to optimize application programming interface scalability in a cloud environment, several illustrative, non-limiting examples are provided herein. It will, however, be appreciated that other methodologies for optimizing application programming interface scalability in a cloud environment are contemplated within the scope of the disclosure.

As noted above, one such non-limiting example of optimizing application programming interface scalability in a cloud environment may rely on asynchronous processing. For example, by using asynchronous processing (e.g., the asynchronous API processing 424), the application programming interface 420 can process requests in parallel, rather than sequentially, thereby allowing the application programming interface 420 to handle more requests in less time. Another such non-limiting example of optimizing application programming interface scalability in a cloud environment may rely on the use of a message queue 430, particularly for asynchronous processing. A message queue 430 can allow the application programming interface 420 to offload tasks that take a long time to complete, such as data processing or long-running API calls, to a separate queue where they can be processed asynchronously.

As discussed herein, asynchronous processing is a programming technique that generally allows a program to perform multiple tasks concurrently, rather than sequentially. This can improve the performance and efficiency of a program, particularly when tasks take a long time to complete or involve waiting for external resources. There are several ways to implement asynchronous processing in a program, including using asynchronous functions, threads, and/or message queues, such as the message queue 430. For example, one approach to implementing asynchronous processing discussed herein utilizes mathematical modeling techniques and a queuing system.

In a queuing system that utilizes asynchronous processing of application programming interface 420 functions, tasks may be represented as items that enter a queue (e.g., the message queue 430) and are processed by a server. In some embodiments, the server can process multiple tasks concurrently, depending on the capacity of the server. Accordingly, the rate at which tasks enter the queue and the rate at which they are processed by the server can determine the overall performance of the system.

One mathematical model that can be used to analyze the performance of a queuing system is an M/M/k model, or the like (e.g., M/M/c model, M/M/1 model, etc.). In the non-limiting examples described herein, reference is generally made to a M/M/k model that operates under the assumption that tasks arrive at the queue according to a Poisson distribution and that the server processes tasks at a constant rate, although it will be appreciated that other queuing system models are contemplated within the scope of the present disclosure.

In embodiments discussed herein, where the queuing model is an M/M/k model, the model can be used to calculate key performance metrics such as the average number of tasks in the queue, the average waiting time for a task, and/or the utilization of the server. By using a mathematical queuing model, such as the M/M/k model, it can be possible to analyze and optimize the performance of an asynchronous processing system, thereby improving the efficiency and scalability of APIs, particularly in a cloud-based environment that operates according to the API-first paradigm mentioned above.

For purposes of this non-limiting example, an M/M/k model for asynchronous API processing is described in connection with the disclosure. The M/M/k model is a mathematical model used to analyze the performance of a queuing system, such as an asynchronous API processing system (e.g., the system 400). In the M/M/k model, the letters M refer to the statistical distribution of the arrival and processing times of tasks in the system.

For example, the first M represents the arrival rate of tasks, which is assumed to follow a Poisson distribution. This means that the rate at which tasks arrive is assumed to be constant and independent of the number of tasks already in the system. The second M represents the processing rate of the server, which is also assumed to be constant. This means that the server is assumed to process tasks at a fixed rate, regardless of the number of tasks in the system. Finally, the k in the model represents the capacity of the server, which is the maximum number of tasks that the server can process concurrently.

In accordance with embodiments of the present disclosure, the M/M/k model can be used to calculate key performance metrics such as the average number of tasks in the queue, the average waiting time for a task, and/or the utilization of the server. These metrics can be used to analyze and optimize the performance of a asynchronous API processing system, such as the system 400, thereby improving its efficiency and scalability. The following is an example of how the M/M/k model could be used to analyze an asynchronous API processing system, but first several definitions are provided:
Arrival rate (M): The arrival rate (M) (e.g., the first M) represents the average number of tasks that arrive at the application programming interface 420 per unit of time.
Processing rate (M): The processing rate (M) (e.g., the second M) represents the average rate at which the application programming interface 420 processes tasks, in tasks per unit of time.
Capacity (k): The capacity (k) represents the maximum number of tasks that the application programming interface 420 can process concurrently.

Continuing with this non-limiting example, and using the M/M/k model, the average number of tasks in the queue (Lq) can be calculated, as well as the average waiting time for a task (Wq), and the utilization of the server (U). These metrics can then be used to analyze the performance of the application programming interface 420 to identify potential bottlenecks or areas for improvement (e.g., potential ways to optimize the system 400).

In some embodiments, the system 400 can be used to analyze whether a synchronous application programming interface call (or “API call” for brevity) can be converted to asynchronous application programming interface call. It is noted that there are several factors to consider when determining whether a synchronous application programming interface call can be converted to an asynchronous application programming interface call.
Latency: Asynchronous API calls tend to have lower latency than synchronous API calls because they generally do not block the caller while waiting for a response. If the API call is expected to take a long time to complete or involves waiting for external resources, it may be a good candidate for conversion to an asynchronous API call.
Dependencies: Asynchronous API calls do not block the caller, so they are less reliant on the availability of other resources. If the API call depends on other resources that may not always be available, converting it to an asynchronous API call may improve its reliability.
Complexity: Asynchronous API calls can be more complex to implement than synchronous API calls, as they often involve using message queues or other asynchronous programming techniques. If the API call is simple and does not require much processing or interaction with external resources, it may not be worth the added complexity to convert it to an asynchronous API call.
Use cases: Consider the intended use cases for the API call. If the API call is expected to be used frequently and by many users concurrently, converting it to an asynchronous API call may improve its performance and scalability.

In some embodiments, the above factors may be evaluated to determine whether converting a synchronous API call to an asynchronous API call is, first off, feasible and, second off, beneficial (e.g., for optimization of the system 400). In addition, it may be beneficial to test the performance of the API call in different scenarios to determine its suitability for conversion to an asynchronous API call in accordance with embodiments of the present disclosure.

In some embodiments, the system 400 can be used to execute instructions (e.g., computer-executable instructions) to evaluate a mathematical model to analyze the feasibility of converting a synchronous API call to an asynchronous API call. In such embodiments, variables (e.g., the latency of the API call, the availability of dependencies, the complexity of the API call, and/or the expected usage of the application programming interface 420) to be analyzed are defined. Data corresponding to the variables is then collected for a synchronous API call. In some embodiments, collecting this data can include measuring the latency of the API call, estimating the availability of dependencies, evaluating the complexity of the API call, and/or estimating the expected usage of the application programming interface 420.

Statistical and/or mathematical models can then be utilized to analyze the data and determine the relationship between the variables. For example, a regression analysis could be used to determine the impact of latency on the performance of the application programming interface 420, a decision tree could be used to evaluate the trade-offs between complexity and expected usage, and so on and so forth. The results of the analysis can then be used to make a decision about whether it is feasible and beneficial to convert the synchronous API call to an asynchronous API call.

In the event that regression analysis is performed to determine the impact of latency on the performance of the application programming interface 420, data associated with the latency and/or performance of the application programming interface 420 may be collected. Collection of such data can include measuring the latency of the application programming interface under different conditions and recording the performance of the application programming interface, such as the response time or error rate.

These data may then be prepared for analysis. This process may involve cleaning and formatting the data and selecting the appropriate independent and dependent variables. In this non-limiting example, the latency of the application programming interface 420 could be an independent variable and the performance of the application programming interface could be a dependent variable. With respect to cleaning and formatting the data, prior to performing the regression analysis, it is important to ensure that the data is clean and consistent. In order to ensure that the data is clean and consistent, various operations including removing missing or invalid data points, ensuring that the data is in a consistent format, and/or converting any categorical data to numerical data may be performed.

The clean, formatted data may then be used as inputs for performance of the regression analysis. Various types of regression analysis may be used including, but not limited to, linear regression, logistic regression, and/or non-linear regression. In general, the type of regression analysis chosen may be based on a type of regression analysis that best fits the data and/or the relationship between the variables (e.g., the independent and dependent variables).

Subsequent to performance of the regression analysis, the results of the regression analysis may be interpreted. The results of the regression analysis can include the regression equation, which describes the relationship between the independent and dependent variables, among other information. The regression equation can then be used to predict the performance of the application programming interface 420 based on the latency of the application programming interface.

Next, embodiments that utilize a message queueing system, such as the message queue 430, are described. Accordingly, the following non-limiting example is directed to a solution to improve application programming interface 420 scalability using a message queue 430 whereby time-consuming tasks are offloaded to a separate system, thereby allowing the application programming interface 420 to continue processing incoming requests more efficiently.

In this non-limiting example, a message queue service is chosen. The message queue service may be chosen by a user of the system 400 or may be automatically selected by the system 400. In general, the message queue service should be reliable and scalable and may be chosen to suit particular characteristics of the system 400. Several non-limiting examples of message queue services can include Apache Kafka, RabbitMQ, and Amazon SQS, among others. The message queue service may be associated (e.g., may run on and/or be in communication with) the message queue 430.

Next, and in contrast to previous approaches, the application programming interface 420 architecture is modified such that, instead of processing resource-intensive tasks directly within the application programming interface 420, these resource-intensive tasks are sent, as shown at operation 421, to the message queue 430 as messages. In some embodiments, these messages include various information, such as payload data, task type, and/or processing priority, among others.

A worker system 440 is then implemented in the system 400. The worker system is separate from the application programming interface 420 and is implemented in a manner such that the worker system 440 subscribes to the message queue 430. The worker system 440 can then receive information (e.g., messages) from the message queue 430 as shown at operation 423. The worker system 440 can, in some embodiments, process tasks received at operation 423 from the message queue 430 asynchronously. Although a single worker system is illustrated in FIG. 4, so as to not obfuscate the layout of the drawings, multiple worker systems may be implemented in accordance with embodiments of the present disclosure. In embodiments in which multiple worker systems are implemented, the worker systems can operate in parallel, thereby increasing processing capacity and providing horizontal scaling of the system 400, as needed.

Once the worker system 440 (or worker systems in embodiments in which multiple worker systems are implemented) has completed one or more tasks received from the message queue 430, the worker system 440 can cause results of the completed task(s) to be sent back to the application programming interface 420 (as shown at operation 427) and/or the worker system 440 can cause results of the completed task(s) to be sent to a data store 450 (as shown at operation 425). The data store 450 can, in some embodiments, be a database, cache, or other memory resource capable of storing data associated with the completed task(s). In embodiments in which the results of the completed task(s) are sent to a data store 450, the application programming interface 420 can requests results of the completed tasks as needed and/or in response to a user request.

In some embodiments, components of the system 400 may be monitored to determine if changes could be made to scale the application programming interface 420 system to improve the performance thereof. For example, the message queue 430 and/or the worker system 440 can be monitored (e.g., continuously, at periodic intervals, etc.) to determine if adjusting the quantity of message queues (e.g., message queue instances) and/or adjusting the quantity of worker systems (e.g., worker system instances) could be beneficial to performance of the system 400. For example, it could be beneficial to alter the quantity of message queues and/or worker systems in response to fluctuations in demand placed on the application programming interface 420, availability of the application programming interface 420, etc.

In this non-limiting example, the following variables are used:
λ: Arrival rate of incoming API requests (requests per second)
μ: Service rate of API requests (requests per second per worker)
N: Number of workers processing tasks in the message queue
P_w: Probability of a request being offloaded to the message queue (0≤P_w≤1)
P_i: Probability of an API request being processed inline (1−P_w)
R: Average response time of the system (seconds)

To model this system, M/M/N queue theory is utilized, where the arrival and service processes follow Poisson distributions. In addition, it is assumed for purposes of this non-limiting example that the application programming interface 420 has a finite capacity of ‘C’ requests at any given time. Under these constraints, the following operations may be performed in accordance with the disclosure:
1. Calculate P_n, the probability of having ‘n’ requests in the system:

$$P\_n = ( \frac{{( \frac{λ}{μ} )}^{n}}{n !} ) * P\_ 0 \qquad Eq . 1 a$$

$$for$$

$$0 \leq n \leq N$$

$$and$$

$$P\_n = ( \frac{{( \frac{λ}{μ} )}^{n}}{N ! * {N}^{( n - N )}} ) * P\_ 0 \qquad Eq . 1 b$$

$$for$$

$$N \leq n \leq C$$

2. Compute P_0, the probability of having no requests in the system:

$${P}_{0} = \sum \frac{{( \frac{λ}{μ} )}^{n}}{n !} * {P}_{0} \qquad Eq . 2$$

$$for$$

$$0 \leq n \leq N + \sum {( \frac{{( \frac{λ}{μ} )}^{n}}{N ! * {N}^{( n - N )}} )}^{- 1} * P\_ 0$$

$$for$$

$$N \leq n \leq C$$

3. Determine the utilization factor ρ:

$$ρ = \frac{λ}{( N * μ )} \qquad Eq . 3$$

4. Calculate the probability that a request is queued, P_q:

$$P\_q = P\_N * ρ \qquad Eq . 4$$

5. Determine the average number of requests in the system, L:

$$L = N * ρ + ( \frac{{λ}^{2} * P\_w}{2 * ( 1 - ρ )} ) \qquad Eq . 5$$

6. Compute the average number of requests in the queue, L_q:

$${L}_{q} = L = N * ( 1 - P\_w ) \qquad Eq . 6$$

7. Calculate the average response time of the system, R:

$$R = \frac{L}{λ} \qquad Eq . 7$$

8. Compute the average waiting time in the queue, W_q:

$$W\_q = \frac{L\_q}{λ} \qquad Eq . 8$$

Performance of the foregoing operations provides a mathematical model representing the performance of an application programming interface 420 system that employs a message queue 430 for handling resource-intensive tasks. The model includes key performance metrics such as the average response time of the system (R) and the average waiting time in the queue (W_q). By adjusting the model parameters λ, μ, N, and P_w), the performance of the system can be analyzed under various conditions and the optimal configuration for a particular use case can be determined.

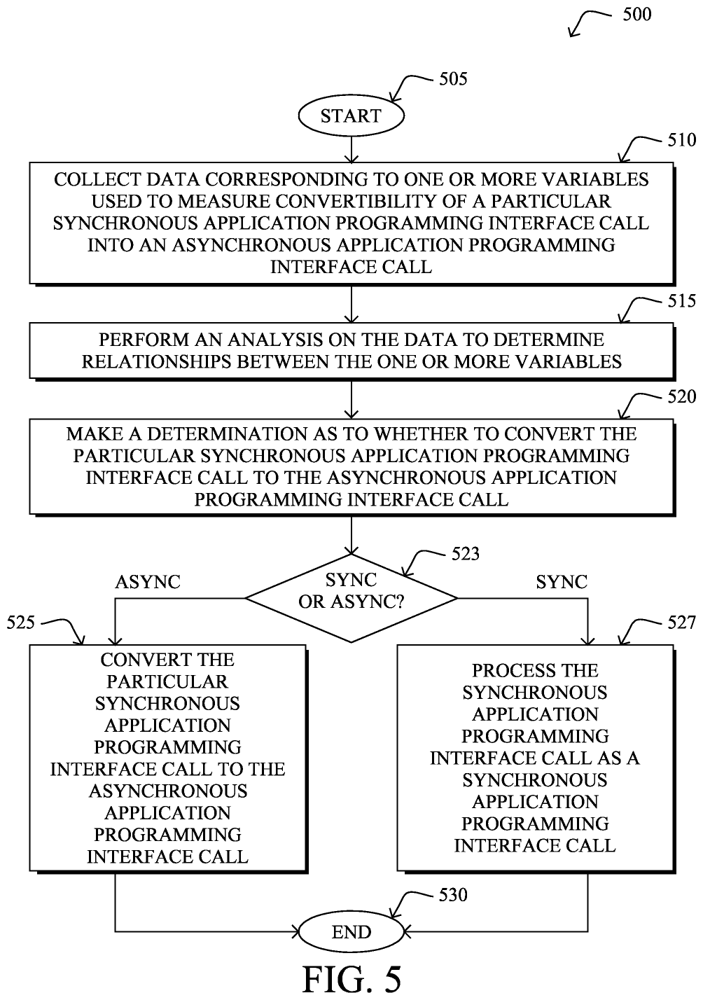

FIG. 5 illustrates an example simplified procedure for optimized application programming interface system scalability in a cloud environment. For example, a non-generic, specifically configured device (e.g., device 200, or other apparatus) may perform procedure 500 (e.g., a method or process) by executing stored instructions (e.g., performance measurement process 248). Alternatively, a tangible, non-transitory, computer-readable medium may have computer-executable instructions stored thereon that, when executed by a processor on a computer, cause the computer to perform a method according to procedure 500.

Procedure 500 may start at step 505, and continues to step 510, where, as described in greater detail above, a process (e.g., the device 200) collects data corresponding to one or more variables used to measure convertibility of a particular synchronous application programming interface call into an asynchronous application programming interface call. In some embodiments, the one or more variables are selected from a group consisting of: latency, resource dependency, complexity, or an expected quantity of concurrent users of the particular synchronous application programming interface call.

At step 515, as detailed above, the process performs an analysis on the data to determine relationships between the one or more variables. In some embodiments, determining a relationship between the one or more variables can include performing regression analysis between independent and dependent variables among the one or more variables. As detailed above, the regression analysis may be performed using a linear regression technique, a logistic regression technique, or a non-linear regression technique, among other regression analysis techniques. Embodiments are not so limited, however, and in some embodiments, a relationship between the one or more variables may be determined by using decision tree logic to evaluate tradeoffs between independent or dependent variables among the one or more variables.

At step 520, as detailed above, the process makes a determination as to whether to convert the particular synchronous application programming interface call to the asynchronous application programming interface call. In some embodiments, the determination is further based on the analysis performed at step 515. For example, a performance of the particular synchronous application programming interface call can be tested in different scenarios to determine the convertibility of the particular synchronous application programming interface call into the asynchronous application programming interface call.

Based on the determination in step 520, shown as decision step 523, the process may convert the particular synchronous application programming interface call to the asynchronous application programming interface call in step 525, or, in contrast, at step 527, does not convert the particular synchronous application programming interface call to the asynchronous application programming interface call, each as described in greater detail above.

According to step 525, in some embodiments as part of converting the particular synchronous application programming interface call to the asynchronous application programming interface call, the process can offload the asynchronous application programming interface call to a separate system and/or a message queuing system, such as the message queue 430 of FIG. 4. The process can include monitoring at least one of a performance, one or more different queues, a response time, or a wait time, or any combination thereof, to identify an optimal configuration for the message queuing system. Further, as detailed above, the process can include offloading the asynchronous application programming interface call to the separate system (e.g., the message queue 430) with information corresponding to at least one of a payload data, a task type, or a priority, or any combination thereof.

As detailed above, a worker system (e.g., the worker system 440 of FIG. 4) can subscribe to the message queuing system and can processes tasks associated with the asynchronous application programming interface call asynchronously. Further, as mentioned above, the worker system can include a plurality of worker systems configured to operate in parallel. The process can monitor the worker system and/or scale the worker system based on monitoring the worker system.

In some embodiments, a result of the asynchronous application programming interface call can be returned via an application programming interface. Embodiments are not so limited, however, and in some embodiments, a result of the asynchronous application programming interface call can be stored in a shared data store (e.g., the data store 450 of FIG. 4) for on-demand retrieval via an application programming interface. As detailed above, the on-demand retrieval can be in response to a user status request or a user task output request.

Procedure 500 then ends at step 530.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques herein therefore provide for optimizing API system scalability, particularly in cloud computing environments. For example, the techniques described herein may allow for increases in the scalability of both existing APIs while allowing for scalability of new APIs that may be added in the future. These and other aspects of the present disclosure can therefore allow for scalability of systems, particularly those that employ APIs in an “API-first” paradigm without hindering performance and/or while providing cost optimization to existing systems.

For example, through utilization of the optimization techniques described herein, optimal performance of APIs and change the type of APIs may be determined in a manner that provides optimum scalability, thereby addressing one of the most challenging aspects of API management-namely-API scalability.

While there have been shown and described illustrative embodiments that provide for optimizing API system scalability, it is to be understood that various other adaptations and modifications may be made within the spirit and scope of the embodiments herein. For example, while certain embodiments are described herein with respect to using the techniques herein for certain purposes, the techniques herein may be applicable to any number of other use cases, as well. In addition, while certain types of scripting languages and common data formats are discussed herein, the techniques herein may be used in conjunction with any scripting language or common data format. Also, while certain configurations and layouts of graphical representations have been shown herein, other types not specifically shown or mentioned may also be used, and those herein are merely examples.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
collecting, by a process, data corresponding to one or more variables used to measure convertibility of a particular synchronous application programming interface call into an asynchronous application programming interface call;
performing, by the process, an analysis on the data to determine relationships between the one or more variables;
making a determination, by the process and based on the analysis, as to whether to convert the particular synchronous application programming interface call to the asynchronous application programming interface call; and
converting, by the process and based on the determination, the particular synchronous application programming interface call to the asynchronous application programming interface call.

2. The method as in claim 1, further comprising:
offloading the asynchronous application programming interface call to a separate system as part of converting the particular synchronous application programming interface call to the asynchronous application programming interface call.

3. The method as in claim 2, wherein the separate system comprises a message queuing system.

4. The method as in claim 3, wherein a worker system subscribes to the message queuing system and processes tasks associated with the asynchronous application programming interface call asynchronously.

5. The method as in claim 4, wherein the worker system comprises a plurality of worker systems configured to operate in parallel.

6. The method as in claim 4, further comprising:
monitoring the worker system; and
scaling the worker system based on monitoring the worker system.

7. The method as in claim 3, further comprising:
monitoring at least one of a performance, one or more different queues, a response time, or a wait time, or any combination thereof, to identify an optimal configuration for the message queuing system.

8. The method as in claim 3, further comprising:
offloading the asynchronous application programming interface call to the separate system with information corresponding to at least one of a payload data, a task type, or a priority, or any combination thereof.

9. The method as in claim 2, further comprising:
returning a result of the asynchronous application programming interface call via an application programming interface.

10. The method as in claim 2, further comprising:
storing a result of the asynchronous application programming interface call in a shared data store for on-demand retrieval via an application programming interface.

11. The method as in claim 10, wherein the on-demand retrieval is in response to a user status request or a user task output request.

12. The method as in claim 1, wherein the one or more variables are selected from a group consisting of: latency, resource dependency, complexity, or an expected quantity of concurrent users of the particular synchronous application programming interface call.

13. The method as in claim 1, further comprising:
determining a relationship between the one or more variables by performing regression analysis between independent and dependent variables among the one or more variables.

14. The method as in claim 13, further comprising:
performing the regression analysis using a linear regression technique, a logistic regression technique, or a non-linear regression technique.

15. The method as in claim 1, further comprising:
determining a relationship between the one or more variables by using decision tree logic to evaluate tradeoffs between independent or dependent variables among the one or more variables.

16. The method as in claim 1, further comprising:
testing a performance of the particular synchronous application programming interface call in different scenarios to determine the convertibility of the particular synchronous application programming interface call into the asynchronous application programming interface call.

17. A tangible, non-transitory, computer-readable medium having computer-executable instructions stored thereon that, when executed by a processor on a computer, cause the computer to perform a method comprising:
collecting, by a process, data corresponding to one or more variables used to measure convertibility of a particular synchronous application programming interface call into an asynchronous application programming interface call;
performing, by the process, an analysis on the data to determine relationships between the one or more variables;
making a determination, by the process and based on the analysis, as to whether to convert the particular synchronous application programming interface call to the asynchronous application programming interface call; and
converting, by the process and based on the determination, the particular synchronous application programming interface call to the asynchronous application programming interface call.

18. The tangible, non-transitory, computer-readable medium as in claim 17, wherein the computer-executable instructions are further executable to perform the method comprising:
offloading the asynchronous application programming interface call to a separate system as part of converting the particular synchronous application programming interface call to the asynchronous application programming interface call.

19. The tangible, non-transitory, computer-readable medium as in claim 18, wherein the separate system comprises a message queuing system.

20. An apparatus, comprising:
one or more network interfaces to communicate with a network;
a processor coupled to the one or more network interfaces and configured to execute one or more processes; and
a memory configured to store a process that is executable by the processor, the process, when executed, configured to:
collect data corresponding to one or more variables used to measure convertibility of a particular synchronous application programming interface call into an asynchronous application programming interface call;
perform an analysis on the data to determine relationships between the one or more variables;
make a determination, based on the analysis, as to whether to convert the particular synchronous application programming interface call to the asynchronous application programming interface call; and
convert, based on the determination, the particular synchronous application programming interface call to the asynchronous application programming interface call.
